(19) United States
(12) Patent Application Publication
(10) Pub. No.: US 2006/0253346 A1
(43) Pub. Date: Nov. 9, 2006

(54) Method and apparatus for bar code driven drug product verification with equivalency links

(76) Inventor: Michael R. Gomez, Stamford, CT (US)

Correspondence Address: Gordon & Jacobson, P.C., Suite 407, 60 Long Ridge Road, Stamford, CT, 06902, US

(21) Appl. No.: 11/103,685

(22) Filed: Apr. 12, 2005

(51) Int. Cl. G06Q 99/00

(52) U.S. Cl. 705/28

(57) ABSTRACT

An improved apparatus and corresponding method are provided for verification of drugs to be dispensed by a pharmacy. A data processing platform and a bar code scanner perform first and second scanning operations. In the first scanning operation, a first bar code symbol (which is part of a prescription label for a given prescription) is scanned and the results are processed to recover the first code number encoded therein (which is assigned to the particular drug product of the given prescription). In the second scanning operation, a second bar code label (which is affixed to a selected container from the inventory of drug products maintained by the pharmacy) is scanned and the results are processed to recover the second code number encoded therein (which is assigned to the particular drug product held in the selected container). If the first and second code numbers match, the bar code verification is successful. If a match is not found, a database of equivalency links is accessed to determine if the second code number is equivalent to the first code number, The results of such equivalency link processing is used in selectively dispensing the drug product from the selected one container. Such operations allow for accurate dispensing of generic equivalents (or functional analogs) as specified by an authorized user of the system.

### BACKGROUND OF THE INVENTION

1. Field of the Invention

This invention relates to pharmacy systems for the dispensing of pharmaceutical drugs and other medicaments in accordance with prescriptions issued by doctors. This invention more particularly relates to tablet counters and automatic tablet dispensing stations which count and/or dispense tablets.

2. State of the Art

Modern pharmacies typically include a pharmacy management computer system that maintains a database of information that generally includes customers, doctors and other health care providers, prescriptions to be filled, prescription that have been filled, etc. In addition, the management computer system typically includes features that enable efficient processing of prescriptions, such as

the ability to refill prescriptions for a given customer with just a few keystrokes or mouse clicks;

the ability to set up refill control for state requirements;

the ability to screen prescriptions against customer records for duplicate prescriptions, drug-disease conflicts, allergies, and patient compliance based on timeliness of refills;

the ability to link codes and free text to quickly produce detailed directions;

the ability to write notes regarding patients, doctors, drugs, and prescriptions;

the integration of or linking to subsystems that provide for electronic submission of claims/billing;

the integration of or linking to subsystems that provide for inventory management and price quotes; and

the integration of or linking to subsystems that provide for accounts receivable management.

The pharmacy management computer system also includes a label print function that generates a printer command file in response to a user requesting that a given prescription label be printed. This printer command file is supplied to a printer, which processes the file and prints the prescription label. The prescription label is typically organized as a two dimensional array of data fields that stores information including a patient name, prescription number, drug name and strength, quantity to be dispensed, patient instructions, doctor name, price paid by patient, etc.

In addition, modern pharmacies typically include tablet counters and/or automatic tablet dispensing systems (collectively referred to herein as “automatic tablet counting/dispensing systems” or “automatic tablet counting/dispensing subsystems”) to assist the pharmacy in filling prescriptions. For purposes of brevity, reference to “tablets” should be understood herein as being generic to tablets, capsules, caplets and any other solid dose medication.

Generally, there are three types of tablet counters available for dispensing prescription medication from bulk containers of such medications: a preset counter, a pour-through counter and a cassette counter.

With a preset-type tablet counter, the user obtains a bulk container of a prescription medication from a shelf and then pours from the container a quantity of tablets into a hopper of the tablet counter. The pharmacist then sets the tablet counter to the number of tablets to be counted, e.g., ninety. Assuming at least the required number of tablets for the prescription has been poured into the hopper, the user waits while the counting apparatus counts the required number of tablets and dispenses the tablets into a patient prescription vial. The excess tablets are discharged back into the bulk container, which is then replaced on the shelf.

A pour-through-type tablet counter does not include a hopper that temporarily stores the medication. Rather, the user pours tablets from a bulk container directly into a funnel which drops the tablets past a counter and dispenses them into a patient vial. The user pours until the digital readout of the counter apparatus displays the required number of tablets, and then stops. As such, there is usually no excess. However, should an extra tablet or so fall into the funnel, the readout clearly indicates the extra number, and the excess can easily be removed by the user and returned to the bulk container.

In order to minimize the time taken to dispense a prescription, cassette-type tablet counters have been developed. The cassette-type tablet counter includes a set of cassettes each designed for a specific size and shape capsule, tablet, or caplet. The cassettes are pre-filled by the user with bulk quantities of the appropriate prescription drugs, and are used to store bulk quantities rather than using the bulk container supplied by the manufacturer or distributor. The prescription medication is then dispensed directly from the cassette. The use of cassettes eliminates the time needed to open the manufacturer's original container, the time needed to return excess tablets to the container, and the time needed to close the container.

Automatic tablet dispensing systems are generally robotic-based systems that count and dispense tablets from prefilled cassettes into containers. In addition, such systems may automatically print and apply the prescription label (and possibly other labels) on the container and deliver the containers for final inspection. An exemplary automatic tablet dispensing system is described in detail in Williams et al., U.S. Pat. No. 6,036,812, incorporated by reference in its entirety.

In order to limit errors in the counting and dispensing of prescription medications, it is common place for such tablet counters and automatic tablet counting/dispensing systems to employ a bar code label verification process as outlined in FIG. 1. In this process, a bar code reader reads two separate bar code labels in steps 101 and 103. In step 101, the reader reads the bar code label affixed to the bulk container, while in step 103, the reader reads the bar code label is affixed to (or part of) the prescription label. The bar code label affixed to the bulk container can utilize one of the many bar code symbologies (e.g., UPC-A, EAN-13, code 39, or code 128) to encode the National Drug Code (NDC) number for the particular pharmaceutical product stored therein. The NDC is a unique 10-digit code that includes three fields that identify a manufacturer (manufacturer source identifier), drug name (product identifier) and pack size (trade package identifier) for the particular pharmaceutical. Equivalent codes are used in other countries. Similarly, the bar code label affixed to (or part of) the prescription label can utilize one of the many bar code symbologies (UPC-A, EAN-13, code 39, code 128) to encode the NDC number for the particular pharmaceutical product dictated by the prescription label. In some instances, the bar code on the prescription label may encode “stuff” characters for the pack size (when it is not relevant to the prescription) and/or additional information such as a prescription ID number (typically referred to as an Rx Number) and a count number (i.e., the desired number of tablets to be counted and dispensed in filling the given prescription).

The bar code label reader automatically outputs the bar code label data read from the two bar code labels to a host data processing system. In step 105, the host processing system recovers a first NDC number from the bar code label data derived from step 101. In step 107, the host processing system recovers a second NDC number from the bar code label data derived from step 103.

In step 109, the host data processing system compares the first and second NDC numbers to ascertain whether they match. In other words, the host data processing system determines whether the two NDC numbers correspond to the same pharmaceutical product. During this comparison operation, corresponding portions of the two NDC numbers (such as the pack size) may be ignored. If this comparison fails (i.e., the two NDC numbers do not match), an “alarm” event (such as a characteristic alarm beep or alarm message/display) is communicated to the user and the counting and dispensing functions of the system are disabled in step 111. If this comparison is successful (i.e., the two NDC numbers match), a “success” event (such as a characteristic success beep or success message/display) is communicated to the user (block 113) and the counting and dispensing operations of the system are enabled.

In some circumstances, the pharmacist desires that a generic substitute be substituted for the prescribed drug. In such circumstances, the bar code label verification process as described above results in a verification error because the two NDC numbers do not match. Such verification error typically requires intervention by the pharmacist and thus causes an unwanted disruption in the workflow of the pharmacy.

A proposed solution to this problem, which is described in U.S. Patent App. No. 2005/0004700 to DiMaggio, allows the pharmacist to substitute a generic drug for the prescribed drug during the data entry operations when the prescription “order” is entered into the pharmacy management computer system (e.g., before the prescription label is printed and the bar code verification operations are performed). This solution requires technical expertise in programming the pharmacy computer system and thus is costly to implement. Moreover, because the inventory of generic drugs carried by a pharmacy typically changes over a short period of time (e.g., from month-to-month or from week-to-week), such costs are compounded and thus make this solution infeasible for most pharmacies.

Thus, there is a need in the art for a cost-effective mechanism that allows the pharmacist to substitute a generic substitute for a prescribed drug in a manner that does not cause unwanted disruptions in the workflow of the pharmacy, including bar code verification operations carried out during the counting and dispensing of prescribed medications.

### SUMMARY OF THE INVENTION

It is therefore an object of the invention to provide an improved apparatus (and corresponding method of operation) that allows a pharmacist (or other user) to substitute a generic substitute for a prescribed drug in a manner that does not cause unwanted disruptions in the workflow of the pharmacy.

It is an additional object of the invention to provide such and apparatus and method wherein the pharmacist can easily define equivalencies between drug products for use in subsequent bar code verification operations.

It is a further object of the invention to provide such an apparatus and method that allows for efficient access and maintenance of data that represents such equivalencies.

In accord with these objects, which will be discussed in detail below, an improved apparatus and corresponding method are provided for verification of drugs to be dispensed by a pharmacy. A data processing platform and a bar code scanner perform first and second scanning operations. In the first scanning operation, a first bar code symbol (which is part of a prescription label for a given prescription) is scanned and the results are processed to recover the first code number encoded therein (which is assigned to the particular drug product of the given prescription). In the second scanning operation, a second bar code label (which is affixed to a selected container from the inventory of drug products maintained by the pharmacy) is scanned and the results are processed to recover the second code number encoded therein (which is assigned to the particular drug product held in the selected container). If the first and second code numbers match, the bar code verification is successful. If a match is not found, a database of equivalency links is accessed to determine if the second code number is equivalent to the first code number, The results of such equivalency link processing is used in selectively dispensing the drug product from the selected container. Such operations allow for accurate dispensing of generic equivalents (or functional analogs) as specified by an authorized user of the system.

In the preferred embodiment of the invention, the data processing platform is adapted to automatically generate different notification events (e.g., display messages or tones) depending upon the outcome of the direct code matching operations and the equivalency link processing operations in order to communicate the appropriate verification status to a user.

Moreover, in the preferred embodiment of the invention, the data processing platform interfaces to a tablet feeder and/or tablet counter, and controls the operation of these automatic tablet dispensing components depending upon the outcome of the direct code matching operations and the equivalency link processing operations in order to improve the accuracy of the automatic dispensing operations carried out by such components within the pharmacy.

Each equivalency link is preferably associated with time-related data that is used to delete the corresponding equivalency link after the expiration of a time period corresponding thereto. Such deletion ensures that stale links are removed from the system as needed. Moreover, the equivalency links are preferably created via user iterations that are performed in response the outcome of the equivalency link processing operations that are carried out during bar code verification of a prescription.

Additional objects and advantages of the invention will become apparent to the skilled in the art upon reference to the detailed description taken in conjunction with the provided figures.

### BRIEF DESCRIPTION OF THE DRAWINGS

FIG. 1 is a flow chart of a prior art bar code verification process carried out as part of the workflow of a pharmacy in dispensing prescribed medications.

FIG. 2A is a functional block diagram of a tablet counting and dispensing system in accordance with the present invention.

FIG. 2B is an exemplary data structure that realizes an equivalency link between two NDC numbers for use in the bar code verification operations of FIGS. 3A and 3B.

FIGS. 3A and 3B, collectively, is a flow chart illustrating operations of the tablet counting and dispensing system of FIG. 2A in accordance with the present invention.

FIG. 4 is a flow chart illustrating the verification override processing operations carried out by the tablet counting and dispensing of FIG. 2A in accordance with the present invention.

FIG. 5 is a flow chart illustrating operations carried out by the processing platform of FIG. 2A for the creation and storage of an equivalency link in accordance with the present invention.

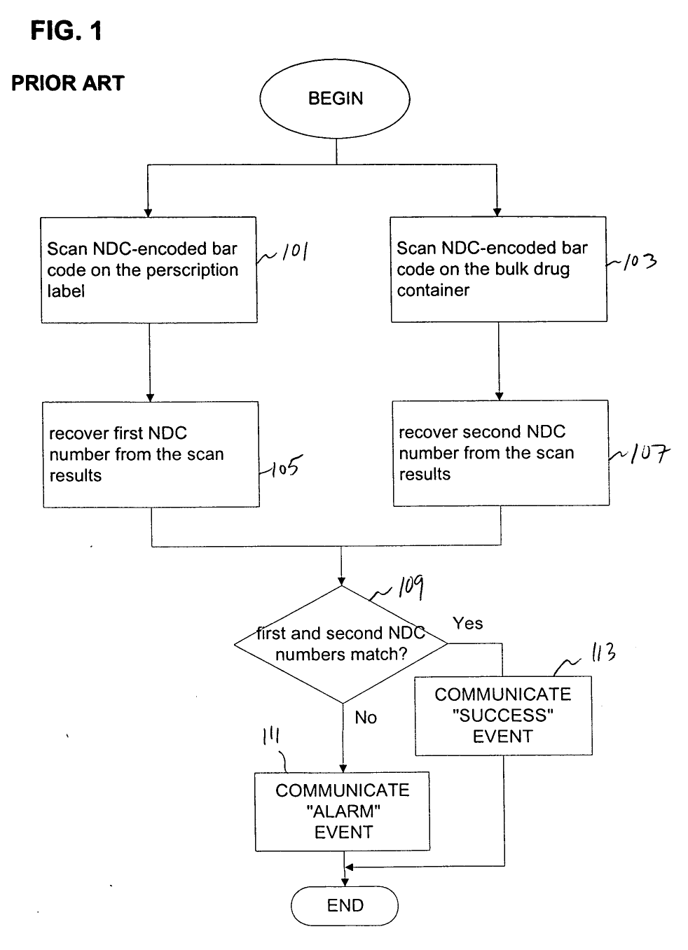

### DETAILED DESCRIPTION OF THE PREFERRED EMBODIMENTS

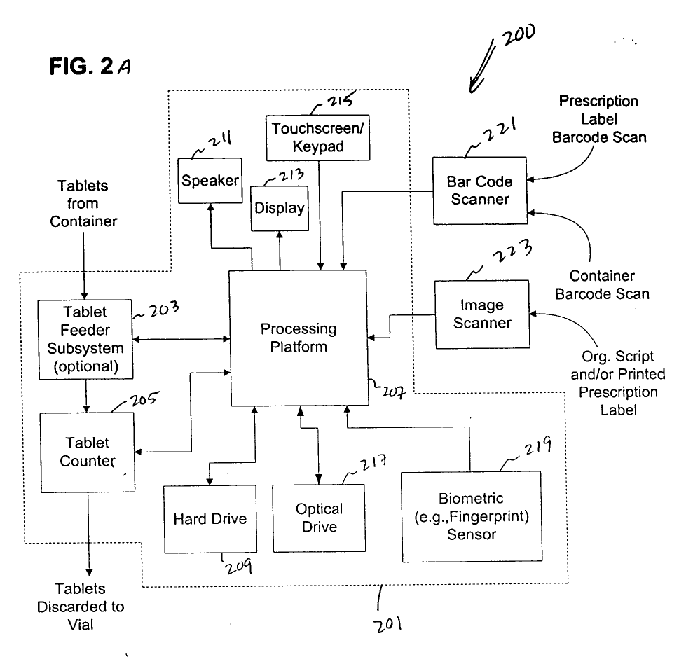

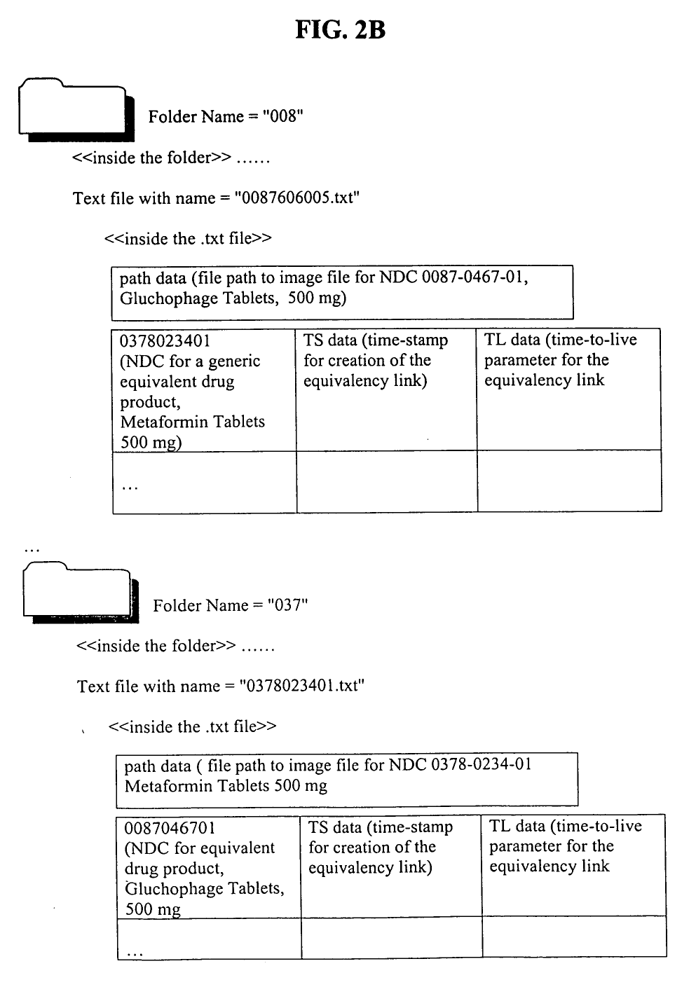

Turning now to FIG. 2A, an exemplary tablet counting and dispensing system 200 in accordance with the present invention includes a system housing 201 that houses a tablet feeder 203, a tablet counter 205 and a data processing platform 207. The tablet feeder 203 feeds tablets supplied thereto to the tablet counter 205. The tablet counter 205 counts the tablets fed by the tablet feeder 203 as part of the tablet dispensing operations carried out by the system 200. The data processing platform 207 (e.g., one or more printed circuit boards that include a microprocessor, memory, and interface circuitry mounted thereon) interfaces to the tablet counter 205 and possibly the tablet feeder 203 to control the operations of the system 200 during the tablet counting and dispensing operations carried out by the system.

The tablet feeder 203 and tablet counter 205 may be of any type known in the art suitable for counting medicament tablets, including a preset-type tablet counter, a pour-through-type tablet counter, or a cassette-type tablet counter. For example, the tablet feeder 203 may be a vibratory bowl feeder as described in U.S. Pat. No. 6,497,339, a mechanical feeder such as the rotating assembly described in U.S. patent application Ser. No. 10/849,092, filed on May 19, 2004, or a cassette system such as described in U.S. Pat. No. 6,659,304, which are commonly assigned to assignee of the present invention and hereby incorporated by reference in their entirety. The tablet feeder 203 preferably feeds tablets in a singulated manner to the tablet counter 205. The tablet counter 205 is preferably an optical system which uses an optical sensor array, such as that disclosed in co-owned U.S. Pat. No. 5,768,327, which is commonly assigned to assignee of the present invention and is hereby incorporated by reference in its entirety. The optical sensor array of U.S. Pat. No. 5,768,327 includes an orthogonal arrangement of two discrete optical sensors which together sense objects in three dimensions. This sensor arrangement is adapted to sense multiple objects simultaneously falling past the sensors. The system 200 may include a storage compartment or possibly a cell-based architecture (such as the cell-based architecture as described in U.S. patent application Ser. No. 10/770,823, filed on Feb. 3, 2004, commonly assigned to assignee of the present invention and herein incorporated by reference in its entirety) that accumulates the tablets counted by the tablet counter 205 prior to discharge from the system 200.

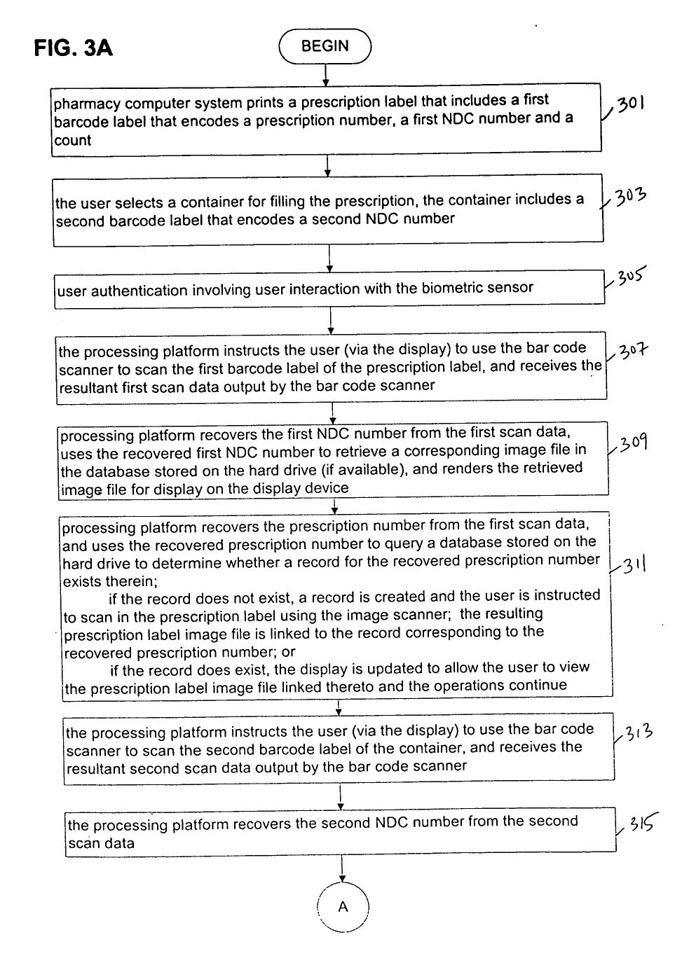

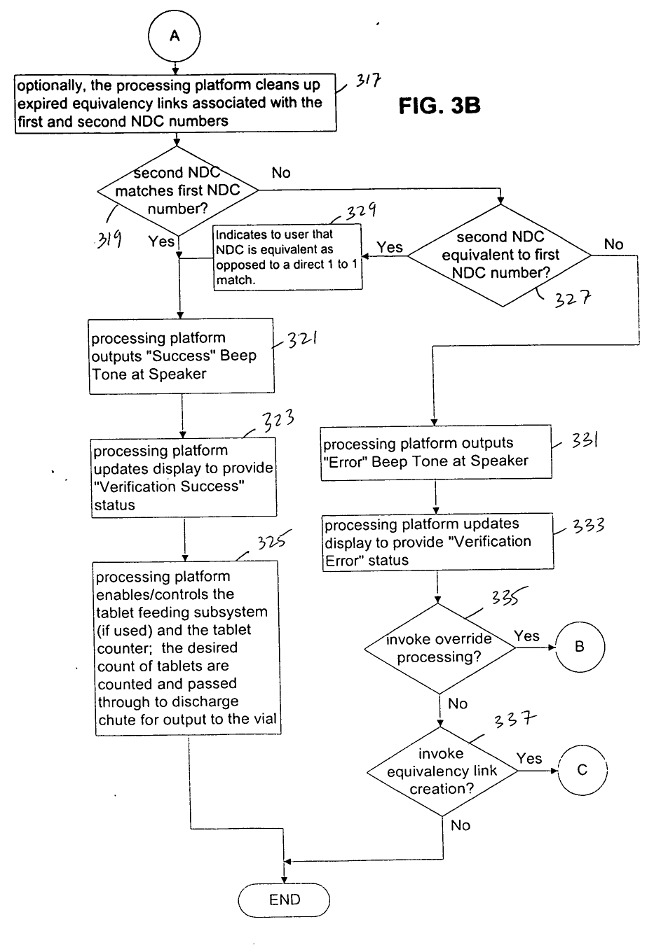

The data processing platform 207 interfaces to a number of components that are housed within the system housing 201, including non-volatile data storage 209 (which may be realized by a hard drive, flash memory or other suitable non-volatile memory means), an audio speaker 211, a display 213 (such as an LCD screen), and user-input means 215. The data processing platform 207 (which is preferably realized by a printed circuit board having a microprocessor, memory and supporting interface circuitry) executes an operating system and application logic that is persistently stored in the non-volatile data storage 209 and loaded onto the data processing platform 207 for execution thereon. Such execution provides for automatic control over the system 200 in accordance with the operations described herein (FIGS. 3A, 3B, 4 and 5). The user-input means 215 preferably provides the user with the ability to, inter alia, input the desired count, while the display 213 preferably provides status messages to the user, including the number of tablets counted by the tablet counter 205. In automatic tablet dispensing systems, the user-input means 215 may be provided from another data processing system that is coupled to the system 200 over a communication link therebetween.

The data processing platform 207 also preferably interfaces to an optical drive 217 (which may be realized by a CDROM drive, DVD-ROM drive or other suitable device), a biometric sensor 219 (which may be realized by a fingerprint sensor a voice print analyzer, or other suitable means), a bar code scanner 221, and an image scanner 223. The optical drive 217 and biometric sensor 219 are preferably housed within the housing 201; yet alternatively can be mechanically supported in independent housings and interfaced to the data processing platform 207 through suitable connection means. The bar code scanner 221 and image scanner 223 are preferably mechanically supported in independent housings and interfaced to the data processing platform 207 through suitable connections (such as a wired or wireless data link therebetween). Alternatively, the bar code scanner 221 and/or the image scanner 223 can be housed within the housing 201. In addition, the tablet counting and dispensing system 200 may include a printer (not shown) that prints the prescription label (and/or a vial label). In automatic dispensing systems, the vial label is automatically applied to the vial for delivery to the patient.

The non-volatile data storage 209 stores an image database that maintains image files for a large number of commercially available drugs indexed by NDC number (hereinafter referred to as the “drug image database”). Each image file is an electronic image of a particular drug as identified by its corresponding NDC number. The drug image database is updated periodically by loading update files stored on an optical disk into the system via the optical drive 217. Alternatively, the drug image database may be updated from a remote computer system coupled thereto over a network link (e.g., over a LAN or WAN/Internet).

The non-volatile data storage 209 also stores a database of records indexed by prescription numbers (hereinafter referred to as the “prescription record database”). The records preferably include, for each prescription number, an image file of the original script of the prescription (as written by the doctor) and image file of the printed prescription label for the prescription number. These image files are loaded into the prescription record database by the image scanner 223.

The non-volatile data storage 209 also stores a database of equivalency links (hereinafter referred to as the “equivalency link database”). Each equivalency link is a data structure that links two NDC numbers as “equivalent”. In the preferred embodiment, the equivalency link database is realized by a folder hierarchy and text files as shown in FIG. 2B. Each folder corresponds to a range of NDC numbers and is named with an NDC prefix corresponding to this range. Each text file corresponds to a different NDC number and is named with the corresponding NDC number. Thus, the text file for a given NDC number is stored within a folder whose range overlaps the given NDC number. In this case, an equivalency link between a two arbitrary NDC numbers “NDC#1” and “NDC#2” includes a folder and text file corresponding to “NDC#1” with “NCD#2 added to this text file together with a folder and text file corresponding to “NDC#2” with “NDC#1” added to this text file. In FIG. 2B, an equivalency link is shown between NDC 0087-6060-05 (Glucophage Tablets, 500 mg) and NDC 0378-0234-01 (Metformin Tablets, 500 mg). Moreover, as shown in FIG. 23, each text file preferably maintains path data that defines the file path to the image file for the corresponding NDC number as well as the following parameters for each equivalent NDC number: a time stamp that records the date and time of creation of the equivalency link, a time-to-live parameter associated therewith, and user data that identifies the user that created the equivalency link. After the expiration of a time period dictated by the time stamp and the time-to-live parameter for a given equivalency link, the given equivalency link is automatically removed from the database (block 317). As will become apparent from the description below, such equivalency links are used during automatic bar code verification to link the NDC number of a particular drug with the NDC number of a generic equivalent or functional analogue during bar code verification. Moreover, such equivalency links are easy to create by an authorized user of the system.

For security purposes and improved compliance, the users of the system 200 may be logically organized into classes (for example, “pharmacist”, “technician-grade A” (for licensed and/or experienced technicians) and “technician-grade B” (for unlicensed and/or inexperienced technicians). Certain operations, such as the “verification override” and “equivalency link creation” can be performed only by the user(s) assigned to certain classes (e.g., only a user belonging to the “pharmacist” class). Alternatively, such operations can be controlled at the user level (i.e., on a user-by-user basis). These features allow that the decision making logic that is automatically programmed into the system to be dictated by the appropriate personnel within the pharmacy and thus aid in the security and compliance of the system.

FIGS. 3A and 3B are flow charts illustrating the pharmacy workflow in conjunction with the operations of the tablet counting and dispensing system 200. The operations begin in block 301 wherein the prescription label is printed (for example, via user interaction with the pharmacy computer system). The prescription label includes a first barcode label that encodes a prescription number (i.e., Rx number), a first NDC number that identifies the particular drug name and strength (e.g., particular NDC code) for the prescribed drug, and the prescribed count that is to be dispensed for the prescription.

In block 303, the user selects a bulk container that holds the medicament tablets that are to be used in filling the prescription. The bulk container includes a second barcode label that encodes a second NDC number that identifies the particular drug name and strength (e.g., particular NDC code) held within the container. The medicaments tablets held in the selected bulk container might match the prescribed drug, might be a generic substitute (or functional analog) of the prescribed drug, or might be selected in error.

In block 305, the user interacts with the biometric sensor 219 for authentication purposes. In an illustrative embodiment, the biometric sensor 219 is a fingerprint sensor. Everyone is known to have unique, immutable fingerprints. A fingerprint is made of a series of ridges and furrows on the surface of the finger. The uniqueness of a fingerprint can be determined by the pattern of ridges and furrows as well as the minutiae points. Minutiae points are local ridge characteristics that occur at either a ridge bifurcation or a ridge ending. The fingerprint sensor scans a finger presented to it and matches the location of the minutiae points of the fingerprint to the minutia point locations of other fingerprints that it stores or has access to. A wide number of fingerprint sensors are commercially available including, for example, the VPASS fingerprint sensor distributed by Bioscrypt Inc. of Mississauga, Ontario, Canada. If the presented fingerprint matches a stored fingerprint, the sensor communicates the user ID associated with the stored fingerprint to the processing platform 207. Upon receipt of a valid user ID, the processing platform 207 identifies and stores the class associated the user ID, which is used for control over subsequent operations of the system as described below, and enables continued processing (blocks 307 and on). Otherwise, when the presented fingerprint fails to match a stored fingerprint, the sensor 219 communicates an error message to the processing platform 207. In this case, the continued operations of blocks 307 and on are not performed. In this manner, only users authenticated by the fingerprint sensor can use the system for its intended purpose. Similar authentication operations may be performed for other biometric sensor types. Alternatively, user authentication can be accomplished by other known means, such as user-assigned passwords, a smart card reader, or an RF tag reader.

In block 307, the processing platform 207 instructs the user via the display 213 to use the bar code scanner 221 to scan the first barcode label of the prescription, and receives the resultant first scan data output by the bar code scanner 221.

In block 309, the processing platform 207 recovers the NDC number encoded from the first scan data (referred to as the “first NDC number”), uses the recovered first NDC number to retrieve an image file corresponding thereto from the drug image database stored on the hard disk 209 (if available), and renders the retrieved image file for display on the display 213. The retrieval of the image file corresponding to the first NDC number from the drug image file preferably employs the file path stored in the corresponding text file of the equivalency link database as shown in FIG. 2B. This enables fast and efficient access to the image file.

In block 311, the processing platform 207 recovers the prescription number from the first scan data, and uses the recovered prescription number to query the prescription record database stored on the non-volatile data storage 209 to determine whether a record for the recovered prescription number exists therein. If the record does not exist, a record is created and the user is instructed to scan in the prescription label (and possibly the original script of the prescription) using the image scanner 223. The resulting prescription label image file is linked to the record corresponding to the recovered prescription number. If the record does exist, the processing platform 207 updates the display 213 to allow the user to view the prescription label image file linked thereto and the operations continue.

In block 313, the processing platform 207 instructs the user via the display 213 to use the bar code scanner 221 to scan the second barcode label of the container selected in block 303, and receives the resultant second scan data output by the bar code scanner 221.

In block 315, the processing platform 207 recovers the NDC number encoded from the second scan data (referred to as the “second NDC number”).

In block 317, the processing platform 207 optionally analyzes the time stamp and time-to-live parameters for the equivalency links associated with the first and second NDC numbers (if any) to determine if any of such equivalency links have expired (e.g., does the time period defined by the time stamp and the time-to-live parameter extend beyond the current date/time). Any of such expired equivalency links are discarded from the equivalency link database. Such discard operations are useful in keeping the equivalency link database current, as the inventory of generic drugs carried by a pharmacy typically changes over a short period of time (e.g., from month-to-month or from week-to-week). Furthermore, such discard operations limit the size of the equivalency link database by deleting data that is typically stale.

In block 319, the processing platform 207 determines whether the second NDC number matches the first NDC number. Such matching operations may ignore certain portions of the first and second NDC numbers (such as the pack size). Such matching operations may also be customized for particular prescription label formats by the user as described in detail in U.S. patent application Ser. No. 10/307,824, filed on Dec. 2, 2002, commonly assigned to assignee of the present invention and herein incorporated by reference in its entirety.

If in block 319 it is determined that the first and second NDC numbers match, the operations continue to blocks 321 to 325 wherein the processing platform 207 outputs a “success” beep tone at the speaker 211 (block 321), updates the display 213 to provide a “Verification Success” status message (block 323), and enables/controls the tablet feeding subsystem 203 (if used) and the tablet counter 205 whereby the desired count of tablets is counted and passed through to a discharge chute for output to the vial (block 325). Alternatively, the user notification of “Verification Success” status generated in block 323 may be in the form of activation of a representative LED display or other suitable user notification event.

If in block 327 it is determined that the first and second NDC numbers do not match, the operations continue to block 327 where it is determined if the second NDC number is equivalent to the first NDC number. Such equivalency is determined by searching the equivalency link database to determine if there is a particular equivalency link linking the second NDC number to the first NDC number.

If in block 327 it is determined that the particular equivalency link between the second NDC number and first NDC number exists in the database, the operations continue to block 329 wherein the processing platform 207 provides an indication to the user via the display 213 that the container selected in block 303 is an “Equivalent” to the prescribed drug (as opposed to a direct match), and the operations continue to blocks 321 to 325 as described above. The user notification of the “Equivalent” status generated in block 329 may also be in the form of a representative beep tone, activation of a representative LED display or other suitable user notification event. In such configurations, the operation of block 329 can continue to block 325 (and thus bypass the generation of the user notification events in blocks 321 and 323).

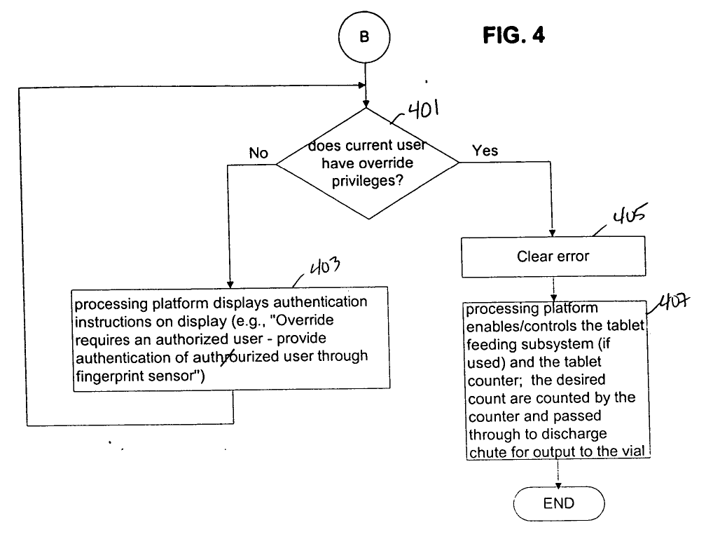

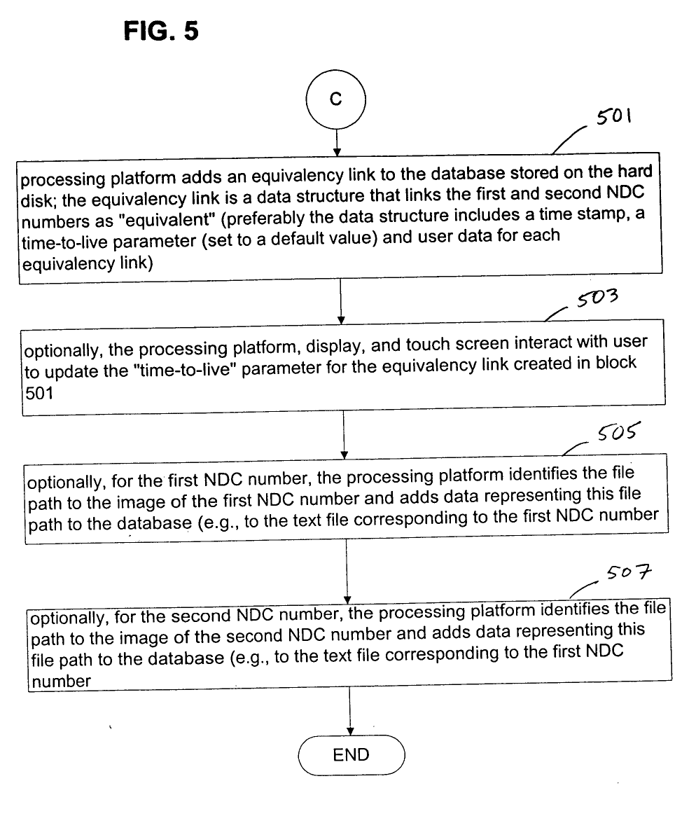

If in block 319 it is determined that the particular equivalency link between the second NDC number and first NDC number does not exist in the database, the operations continues to blocks 331-337 wherein the processing platform 207 outputs an “error” beep tone at the speaker 211 (block 331), updates the display 213 to provide a “Verification Error” status message (block 333), and updates the display 213 to allow the user to invoke override processing (block 335) and equivalency link creation (block 337). Alternatively, the user notification of the “Verification Error” status generated in block 333 may be in the form of activation of a representative LED display or other suitable user notification event. Details of exemplary override processing operations and equivalency link creation are illustrated in FIGS. 4 and 5, respectively. If override operations are not invoked (or fail to result in override authorization) the tablet feeding subsystem 203 (if used) and the tablet counter 205 are not enabled, thus disabling the use of the apparatus 200 in counting the desired number of tablets for filling the vial.

Referring now to FIG. 4, exemplary override processing operations begin in block 401 wherein the processing platform 207 determines whether the current user (e.g., the user authenticated in block 305) belongs to a class of users (or is individually) privileged to override errors that arise in the bar code verification operations of FIGS. 3A and 3B. If not, the operations continue to block 403 wherein the processing platform 207 updates the display 213 to display a message that provides instructions for the authentication of a user that is privileged to override errors that arise in such bar code verification operations and the operations continue back to block 401 to wait for such authentication.

If in block 401 the current user belongs to a class of users (or is individually) privileged to override errors that arise in the bar code verification operations of FIGS. 3A and 3B, the operations continue to blocks 405 and 407 wherein the processing platform 207 allows the user to clear the error via the user input means 215 (block 405), and enables/controls the tablet feeding subsystem 203 (if used) and the tablet counter 205 whereby the desired count of tablets is counted and passed through to a discharge chute for output to the vial (block 407).

Referring now to FIG. 5, exemplary operations for creating an equivalency link begins in block 501 wherein the processing platform 207 adds to the equivalency link database a data structure that links the second NDC number to the first NDC number as “equivalent”. In the preferred embodiment, the database is realized by a folder hierarchy and text files as described above with respect to FIG. 2B. In this configuration, a data structure linking the second NDC number “NDC#2” to the first NDC number “NDC#1” includes a folder and text file corresponding to “NDC#2” with “NCD#1 added to this text file together with a folder and text file corresponding to “NDC#1” with “NDC#2” added to this text file. Moreover, each text file maintains, for each equivalent NDC number, the following parameters: a time stamp that records the date and time of creation of the equivalency link, a time-to-live parameter, and user data that identifies the user that created the equivalency link as shown in FIG. 2B. Preferably, in block 501, the time-to-live parameter for the equivalency link data structure is initialized to a default value, which is preferably dictated by the user during a setup routine (or other interactions). The time-stamp data and time-to-live parameter of the equivalency links are used to discard the equivalency links as described above with respect to block 317.

In block 503, optionally, the processing platform 207, display 213 and user-input means 215 may be used for interaction with the user that updates the time-to-live parameter of the equivalency link created in block 501.

In block 505, optionally, the processing platform 207 identifies the file path to the image file corresponding to the first NDC number (as stored in the drug image database) and adds data that represents this file path to the text file corresponding to the first NDC number. Finally, in block 507, optionally, the processing platform 207 identifies the file path to the image file corresponding to the second NDC number (as stored in the drug image database) and adds data that represents this file path to the text file corresponding to the second NDC number. The operations of blocks 505 and 507 advantageously enable fast and efficient access to the image file for the corresponding NDC number in block 309.

Advantageously, the bar code based verification methodology of FIGS. 3A, 3B, 4 and 5 enable the end-user pharmacist to efficiently customize the verification process such that equivalent drugs can be filled without raising errors in the verification process. Moreover, the end-user pharmacist can efficiently create the link between the NDC numbers for such equivalent drugs without the need for costly and expensive programming updates to the pharmacy system computer and thus provide for decreased costs to the pharmacy.

In addition, the tablet counting system advantageously integrates together a broad range of components suitable for managing the information that is captured and used in the workflow of the pharmacy. Such components preferably include:

a hard disk or other form of persistent data storage;

an optical drive for data updates to the system;

a biometric sensor for user authentication;

a bar code scanner for bar code verification;

an image scanner for scanning the prescription label, an original prescription script and/or other paper-based information; and

user input and a display for user interaction.

There have been described and illustrated herein a tablet counting and dispensing system that carries out bar code verification using equivalency links. While particular embodiments of the invention have been described, it is not intended that the invention be limited thereto, as it is intended that the invention be as broad in scope as the art will allow and the specification be read likewise. For example, the bar code verification operations described above can be employed in conjunction with other forms of packaging well known in the art such as shrink-wrap packages, blister-packs, single-item packages (typically used for oral suspensions or creams) and the like. Such packaging is referred to as a “container” herein. Moreover, it will be readily appreciated that the apparatus and methodologies described herein can be readily adapted for use in automatic tablet dispensing systems wherein a robot or other automatic mechanism is used to deliver a bulk supply of tablets to a tablet counting and dispensing subsystem. An example of such an automatic tablet dispensing system is described in detail in Williams et al., U.S. Pat. No. 6,036,812, herein incorporated by reference in its entirety. The apparatus and methodologies described herein can also be adapted for use in other bar code driven verification devices, such a bar code scanner/verification apparatus that does not employ functionality for tablet feeding or tablet counting (or in applications where such functionality is not used). It will therefore be appreciated by those skilled in the art that yet other modifications could be made to the provided invention without deviating from its spirit and scope as so claimed.

What is claimed is:

1. A method for automatic verification of drugs to be dispensed in accordance with a prescription that identifies a particular drug product, the method comprising:
a) printing a prescription label corresponding to the prescription, said prescription label including a first bar code symbol that encodes a first code number assigned to the particular drug product of the prescription;
b) performing a first scanning operation wherein said first bar code symbol is scanned, and processing results of the first scanning operation to recover said first code number;
c) selecting a container that holds a drug product, the container having a second bar code label affixed thereto that encodes a second code number assigned to the drug product held in the container;
d) performing a second scanning operation on said second bar code label, and processing results of the second scanning operation to recover said second code number;
e) comparing said first and second code numbers to determine if said first code number matches said second code number;
f) if a match is not determined in e), accessing a database of equivalency links to determine if said second code number is equivalent to said first code number; and
g) selectively dispensing the drug product from said container selected in c) based upon the determination in f).

2. The method according to claim 1, further comprising:
automatically generating a first user notification event if a match is determined in e); and
automatically generating a second user notification event if it is determined that said second code number is equivalent to said first code number in f);
wherein said first and second user notification events are different from one another and communicate verification status to a user.

3. The method according to claim 2, further comprising:
automatically generating a third user notification event if it is determined that said second code number is not equivalent to said first code number in f), wherein said third user notification event is different from said first and second user notification events.

4. The method according to claim 1, further comprising:
h) if a match is determined in e), or if it is determined that said second code number is equivalent to said first code number in f), automatically enabling at least one of a tablet feeder and a tablet counter which carry out automatic dispensing of tablets in accordance with the prescription.

5. The method according to claim 4, wherein:
said first bar code label encodes a count pertaining to the prescription; and
in h) the tablet counter is automatically controlled to count and dispense the number of tablets dictated by the count encoded in the first bar code label.

6. The method according to claim 4, further comprising:
i) if it is determined that said second code number is not equivalent to said first code number in f), automatically disabling at least one of the tablet feeder and the tablet counter.

7. The method according to claim 6, further comprising:
in i) performing override processing operations that allows a user with sufficient privileges to enable at least one of the tablet feeder and the tablet counter.

8. The method according to claim 1, further comprising:
h) if it is determined that said second code number is not equivalent to said first code number in f), allowing the user to create and store an equivalency link that is used for subsequent verification operations.

9. The method according to claim 1, further comprising:
h) storing a drug image database comprising a plurality of electronic images of drug products, said images indexed by code numbers assigned to the drug products; and
i) displaying an image for the particular drug product corresponding to the first code number if the image is stored in said database.

10. The method according to claim 9, wherein:
the equivalency link corresponding to a given drug product includes file path data pointing to an image within the drug image database that represents the given drug product.

11. The method according to claim 1, further comprising:
h) scanning an image of at least one of the prescription label and an original script of the prescription, and adding the image to a database stored locally with said database of equivalency links.

12. The method according to claim 1, further comprising:
h) storing time-stamp data and time-to-live data for each equivalency link, and
i) invoking operations that discard expired equivalency links based upon the time-stamp data and time-to-live data stored for equivalency links.

13. The method according to claim 12, wherein:
the step i) is invoked for equivalency links pertaining to the first code number in response to step b), and the step i) is invoked for equivalency links pertaining to the second code number in response to step d).

14. An apparatus for automatic verification of drugs to be dispensed by a pharmacy in accordance with a prescription that identifies a particular drug product, the pharmacy employing a printer and an inventory of containers holding drug products, wherein the printer prints a prescription label corresponding to the prescription, said prescription label including a first bar code symbol that encodes a first code number assigned to the particular drug product of the prescription, and wherein one of the containers has a second bar code label affixed thereto that encodes a second code number assigned to the drug product held in the container, the apparatus comprising:
a data processing platform and a bar code scanner interfacing with said data processing platform;
said data processing platform and said bar code scanner having means for performing:
i) a first scanning operation wherein said first bar code symbol is scanned and results of the first scanning operation are processed to recover said first code number;
ii) a second scanning operation wherein said second bar code label is scanned and results of the second scanning operation are processed to recover said second code number;
iii) a comparison of said first and second code numbers to determine if said first code number matches said second code number;
iv) if a match is not determined in ii), an operation that accesses a database of equivalency links to determine if said second code number is equivalent to said first code number; and
v) an operation that stores the result of the determination in iv) for use in selectively dispensing the drug product from the one container.

15. An apparatus according to claim 14, wherein:
said data processing platform further comprises:
vi) means for automatically generating a first user notification event if a match is determined in iii); and
vii) means for automatically generating a second user notification event if it is determined that said second code number is equivalent to said first code number in iv);
wherein said first and second user notification events are different from one another and communicate verification status to a user.

16. An apparatus according to claim 15, wherein:
said data processing platform further comprises:
viii) means for automatically generating a third user notification event if it is determined that said second code number is not equivalent to said first code number in iv), wherein said third user notification event is different from said first and second user notification events.

17. An apparatus according to claim 16, further comprising:
a display device operably coupled to said data processing platform, wherein said first, second and third user notification events are comprise status messages displayed on said display device.

18. An apparatus according to claim 14, further comprising:
at least one of a tablet feeder and a tablet counter, operably coupled to said data processing platform, which carry out automatic dispensing of tablets in accordance with the prescription;
wherein, if a match is determined in iii), or if it is determined that said second code number is equivalent to said first code number in iv), said data processing platform automatically enables the tablet feeder and/or the tablet counter.

19. An apparatus according to claim 18, wherein:
said first bar code label encodes a count pertaining to the prescription, and said tablet counter is automatically controlled to count and dispense the number of tablets dictated by the count encoded in the first bar code label.

20. An apparatus according to claim 18, wherein:
if it is determined that said second code number is not equivalent to said first code number in iv), said data processing platform automatically disables the tablet feeder and/or the tablet counter.

21. An apparatus according to claim 20, wherein:
if it is determined that said second code number is not equivalent to said first code number in iv), said data processing platform performs override processing operations that allows a user with sufficient privileges to enable the tablet feeder and/or the tablet counter.

22. An apparatus according to claim 14, wherein:
if it is determined that said second code number is not equivalent to said first code number in iv), said data processing platform allows the user to create and store an equivalency link that is used for subsequent verification operations.

23. An apparatus according to claim 14, wherein:
said data processing platform comprises user input means that allows the user to create and store an equivalency link that is used for subsequent verification operations.

24. An apparatus according to claim 14, further comprising:
persistent storage for storing the database of equivalency links.

25. An apparatus according to claim 24, wherein:
said persistent storage stores a drug image database comprising a plurality of electronic images of drug products, said images indexed by code numbers assigned to the drug products, and said data processing platform displays an image for the particular drug product corresponding to the first code number if the image is stored in said drug image database.

26. An apparatus according to claim 25, wherein:
the equivalency link corresponding to a given drug product includes file path data pointing to an image within the drug image database that represents the given drug product.

27. An apparatus according to claim 14, wherein:
said data processing platform is operably coupled to an image scanner for scanning an image of at least one of the prescription label and an original script of the prescription, wherein the image is added to a database stored locally with said database of equivalency links.

28. An apparatus according to claim 14, wherein:
said database of equivalency links stores time-stamp data and time-to-live data for each equivalency link, and said data processing platform is adapted to invoke operations that discard expired equivalency links based upon the time-stamp data and time-to-live data stored for equivalency links.

29. An apparatus according to claim 28, wherein:
the equivalency link discard operations are invoked for equivalency links pertaining to the first code number in response to step i), and the equivalency link discard operations are invoked for equivalency links pertaining to the second code number in response to step ii).

30. An apparatus according to claim 16, further comprising:
a speaker device operably coupled to said data processing platform, wherein at least one said first, second and third user notification events are comprise status tones output by said speaker device.
